(19) United States
(12) Patent Application Publication
(10) Pub. No.: US 2024/0330702 A1
(43) Pub. Date: Oct. 3, 2024

(54) LEARNING DEVICE, LEARNING METHOD, AND STORAGE MEDIUM

(71) Applicants: NEC CORPORATION, Tokyo (JP); NATIONAL INSTITUTE OF ADVANCED INDUSTRIAL SCIENCE AND TECHNOLOGY, Tokyo (JP)

(72) Inventors: Shumpei KUBOSAWA, Tsukuba-shi (JP); Takashi Onishi, Tsukuba-shi (JP); Yoshimasa Tsuruoka, Tsukuba-shi (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 18/588,863

(22) Filed: Feb. 27, 2024

(30) Foreign Application Priority Data
Mar. 28, 2023 (JP) 2023-051144

(51) Int. Cl. G06N 3/092

(52) U.S. Cl. CPC G06N 3/092

(57) ABSTRACT

A learning device includes at least one memory configured to store instructions; and at least one processor configured to execute the instructions to: perform reinforcement learning of control over a control target; use data used in the reinforcement learning to learn a model that shows the relationship between a state relating to the control target, control over the control target, and a temporal change in the state relating to the control target; and use the model and the result of the reinforcement learning to learn control over the control target.

This application is based upon and claims the benefit of priority from Japanese patent application No. 2023-051144, filed on Mar. 28, 2023, the disclosure of which is incorporated herein in its entirety by reference.

### TECHNICAL FIELD

The present disclosure relates to a learning device, a learning method, and a storage medium.

### BACKGROUND ART

One method of learning control over a control target is reinforcement learning (see, for example, Japanese Unexamined Patent Application Publication No. 2022-014099 (hereinbelow referred to as Patent Document 1)).

It is desirable to be able to perform learning of control over a control target in as short a time as possible.

### SUMMARY

An example of an object of the present disclosure is to provide a learning device, a learning method, and a program that can solve the above-mentioned problem.

According to the first example aspect of the disclosure, a learning device includes: at least one memory configured to store instructions; and at least one processor configured to execute the instructions to perform reinforcement learning of control over a control target; use data used in the reinforcement learning to learn a model that shows the relationship between a state relating to the control target, control over the control target, and a temporal change in the state relating to the control target; and use the model and the result of the reinforcement learning to learn control over the control target.

According to the second example aspect of the disclosure, the learning method executed by a computer, the learning method includes: performing reinforcement learning of control over a control target; using data used in the reinforcement learning to learn a model that shows the relationship between a state relating to the control target, control over the control target, and a temporal change in the state relating to the control target; and using the model and the result of the reinforcement learning to learn control over the control target.

According to the third example aspect of the disclosure, the non-transitory storage medium is a non-transitory storage medium storing a program for causing a computer that executes a learning method comprising: performing reinforcement learning of control over a control target; using data used in the reinforcement learning to learn a model that shows the relationship between a state relating to the control target, control over the control target, and a temporal change in the state relating to the control target; and using the model and the result of the reinforcement learning to learn control over the control target.

According to the present disclosure, it is expected that the time required to learn control over a control target is relatively short.

### BRIEF DESCRIPTION OF THE DRAWINGS

FIG. 1 is a diagram that shows an example of the configuration of a learning device according to an example embodiment.

FIG. 2 is a diagram that shows an example of the steps of the process performed by the learning device according to the present example embodiment.

FIG. 3 is a diagram that shows an example of the system configuration when control is performed on a control target in accordance with the example embodiment.

FIG. 4 is a diagram showing an example of the configuration of the control device according to the example embodiment.

FIG. 5 is a diagram showing another example of the configuration of a learning device according to the example embodiment.

FIG. 6 is a diagram showing an example of the processing steps in the learning method according to the example embodiment.

FIG. 7 is a schematic block diagram showing the configuration of a computer according to at least one example embodiment.

### EXAMPLE EMBODIMENT

The following is a description of example embodiments of the present disclosure, but the following example embodiments do not limit the disclosure as claimed. Not all of the combinations of features described in the example embodiments are essential to the solution of the disclosure.

In the following, a letter with a circumflex may be indicated by adding \hat{ } after the letter. For example, s with a circumflex would be denoted as s\hat{ }.

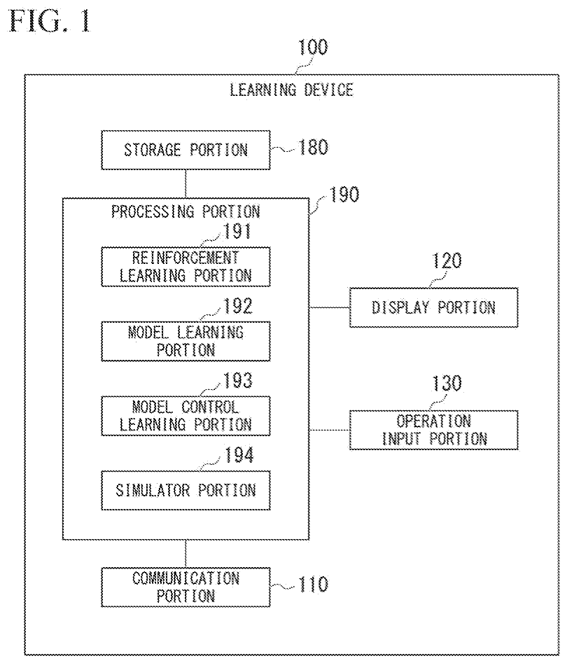

FIG. 1 is a diagram that shows an example of the configuration of a learning device according to the example embodiment. In the configuration shown in FIG. 1, a learning device 100 is provided with a communication portion 110, a display portion 120, an operation input portion 130, a storage portion 180, and a processing portion 190. The processing portion 190 is provided with a reinforcement learning portion 191, a model learning portion 192, a model control learning portion 193, and a simulator portion 194.

The control target that is the target on which the learning device 100 performs learning of the control method is not limited to a specific one. A variety of controllable objects can be the control target. For example, the control target may be a facility such as a plant or factory or a power plant, a system such as a production line in a factory, or a stand-alone device. Alternatively, the control target may be a mobile object such as a car, airplane, ship, or self-propelled mobile robot.

The learning device 100 performs learning of control over the control target. In particular, the learning device 100 performs learning of control over the control target by reinforcement learning and learning using a model that shows the time variation of the state relating to the control target.

The learning device 100 may be configured using a computer, such as a personal computer (PC) or workstation (WS).

Reinforcement learning is machine learning that learns a policy, which is an action rule for an agent that performs an action with respect to an environment, based on a state of the environment and a reward, which represents the evaluation of the state or action.

The combination of the learning device 100 and the control target can be viewed as an example of an agent.

The operating environment of the control target, including the control target, can be taken as an example of the environment.

The operation of the control target based on control by the learning device 100 can be viewed as an example of an action. The following is an example of a case in which the control command to the control target is identical to the operation of the control target. A control command to a control target may be used as information indicating the operation of the control target.

A control rule for a control target can be viewed as an example of a policy.

The operating environment of the control target, including the control target, is also referred to simply as the operating environment of the control target. The state of the operating environment of the control target is also referred to as the state relating to the control target, or simply the state.

The learning device 100 acquires four sets of data, for example (state, action, reward, next state), as training data for reinforcement learning. The learning device 100 performs reinforcement learning using the obtained data. Furthermore, the learning device 100 uses the acquired data to update the model showing the temporal change of the state. In particular, the learning device 100 uses a model that shows the gradient of the state when the control target performs a certain operation in a certain state. This model is also referred to as the gradient model. The gradient model corresponds to an example of a model that shows the relationship between the state relating to the control target, the control over the control target, and the time variation of the state relating to the control target.

The learning device 100 uses the acquired gradient model to learn control over the control target. Thereby, the learning device 100 can performing learning using a gradient method such as backpropagation, and in this respect, can perform learning efficiently.

In the following, the case of using a neural ordinary differential equation (neural ODE), a computational model that represents an ordinary differential equation in a neural network, as a gradient model will be explained as an example. However, the model used by the learning device 100 as a gradient model is not limited to a specific type of model, but can be any model that shows the gradient of the state as described above.

A communication portion 110 communicates with other devices. For example, the communication portion 110 may transmit control commands to the control target and receive sensor measurements from a sensor provided in the control target or the operating environment of the control target.

The display portion 120 has a display screen, such as a liquid crystal panel or Light Emitting Diode (LED) panel, for example, and displays various images. For example, the display portion 120 may display information about the learning conducted by the learning device 100, such as the progress of the learning conducted by the learning device 100.

The operation input portion 130 is equipped with input devices such as a keyboard and mouse, for example, and receives user operations. For example, the operation input portion 130 may receive a user operation to set the value of a hyperparameter for learning, such as the learning rate.

The storage portion 180 stores various data. For example, the storage portion 180 may store the four sets of data obtained in reinforcement learning and a neural ordinary differential equation. The storage portion 180 is configured using the storage device provided by the learning device 100.

The processing portion 190 controls the various parts of the learning device 100 and performs various processes. The functions of the processing portion 190 are performed, for example, by the Central Processing Unit (CPU) provided by the learning device 100 reading and executing a program from the storage portion 180.

The reinforcement learning portion 191 performs reinforcement learning of control over the control target. In particular, the reinforcement learning portion 191 performs reinforcement learning for each of the multiple tasks to be performed by the control target. The reinforcement learning portion 191 is an example of a reinforcement learning means.

The reinforcement learning portion 191 also determines the initial value of the policy used for reinforcement learning using the neural ordinary differential equation learned for the task for which reinforcement learning has been performed.

For example, the reinforcement learning portion 191 may tentatively set the parameter values of a policy as the initial values of the policy, calculate the reward function value when using the parameter values using a neural ordinary differential equation, and adjust the parameter values of the policy so that the reward function value becomes larger (so that the evaluation indicated by the reward function value becomes better). In this case, the reinforcement learning portion 191 may use a gradient method such as backpropagation to adjust the parameter values of the policy.

Here, when no learning results have been accumulated, such as in the early stages of reinforcement learning, it is conceivable to use a policy in which actions are determined randomly. In this case, the likelihood of an action being selected that will result in a good evaluation shown as a reward is relatively low, and it is conceivable that learning may take time. Similarly, if the learning of individual tasks does not use the results of learning from previous tasks, a policy that randomly determines actions may be used, which may take longer to learn.

In contrast, the reinforcement learning portion 191 determines initial values of a policy using a neural ordinary differential equation already learned in regards to a task for which reinforcement learning has already been executed, so that policy decisions can reflect the results of previous task learning. According to the learning device 100, in this respect, it is expected to be easier to select actions that will result in a better evaluation than when using a policy that randomly determines actions, and the time required for learning is expected to be relatively short.

The reinforcement learning portion 191 determines the reward function to be used for reinforcement learning using the neural ordinary differential equation already learned for the task for which reinforcement learning has been performed.

For example, the reinforcement learning portion 191 may tentatively set the parameter values of the reward function, calculate the reward function value when a scenario that results in successful task execution is executed using a neural ordinary differential equation, and adjust the parameter value of the reward function so that the reward function value becomes larger (so that the evaluation indicated by the reward function value becomes better). In this case, the reinforcement learning portion 191 may use a gradient method such as backpropagation to adjust the parameter values of the reward function.

Here, when learning the reward function, it is conceivable that the policy function cannot be properly learned until the learning progresses and an appropriate reward function is obtained. It is conceivable that the learning may take time, especially if the number of parameters to be learned in the reward function is large, such as when the reward function includes the calculation of cumulative rewards and the coefficients for each time step are subject to learning.

In contrast, by having the reinforcement learning portion 191 determine the reward function for reinforcement learning using the neural ordinary differential equation that has already been learned for the task for which reinforcement learning has already been performed, the determination of the reward function can reflect the results of the previous task learning. According to the learning device 100, in this respect, the reward function can be acquired in a shorter time than if the learning results of a task for which reinforcement learning has already been performed are not used, and as a result, it is also anticipated that the time required for policy learning will be relatively short.

The model learning portion 192 learns a neural ordinary differential equation using the data used for reinforcement learning. Specifically, the model learning portion 192 uses the combination of (state, action, next state), as indicated by the training data for reinforcement learning, as training data for learning a neural ordinary differential equation.

In particular, the model learning portion 192 updates the neural ordinary differential equations by learning the neural ordinary differential equations using the data used for reinforcement learning for each of the multiple tasks to be performed by the control target. The model learning portion 192 is an example of a model learning means.

The learning device 100 uses a neural ordinary differential equation as a computational model that receives the input of the state and a control command to the control target, and outputs the time derivative of the state. The neural ordinary differential equation in this case is expressed as in Expression (1).

$$\frac{dx}{dt} = f ( x ( t ) , u ( t ) ) \qquad ( 1 )$$

t denotes time.
x(t) represents the state at time t.
u(t) represents the control command to the control target at time t.
f is a function representing a neural network.

The initial value of time t (start time) is denoted by to. The initial value of state x is denoted by x₀. The initial value x₀ of state x is expressed as in Expression (2).

$$x ( {t}_{0} ) = {x}_{0} \qquad ( 2 )$$

The learning device 100 calculates the state x(t) at time t by integrating the derivative dx/dt of the state. For example, the learning device 100 calculates the state x(t_{f}) at time t_{f} based on Expression (3).

$$x ( {t}_{f} ) = {\int }_{{t}_{0}}^{{t}_{f}} f ( x ( t ) , u ( t ) ) dt \qquad ( 3 )$$

Here, in the neural ordinary differential equation, the derivative may be approximated by a difference.

The learning device 100 may also use numerical integration techniques to calculate the integral.

In the following, the case where time is expressed in time steps will be used as an example.

The model control learning portion 193 uses the neural ordinary differential equation and the results of reinforcement learning to learn control over the control target.

The model control learning portion 193 corresponds to an example of a model control learning means.

The model control learning portion 193 uses the neural ordinary differential equation and the policy obtained by reinforcement learning to generate an initial value of the control time series over the control target up to a finite predetermined period of time in the future, for example, three hours from now.

For example, the model control learning portion 193 may calculate state-specific actions, starting from a given initial state x₀, using the (latest) policy obtained by reinforcement learning, and calculate the next state when the control target performs the action in that state, using a neural ordinary differential equation. Then, for the state obtained as the next state, the model control learning portion 193, by repeating the calculation of the action according to that state and the calculation of the next state when the control target performs that action in that state, may calculate the initial value of the control time series for the control target (the initial value of the time series of the operation performed by the control target).

The model control learning portion 193 updates the time series of control to the control target so that the evaluation indicated by the evaluation function set according to the task to be performed on the control target is as good as possible.

Here, if the accuracy of the initial values of the time series of control to the control target used by the model control learning portion 193 is low, it may take time to search for time series with good evaluations indicated by the evaluation function, and the time required for learning performed by the model control learning portion 193 may be relatively long.

In contrast, if the model control learning portion 193 uses the (tentative) results of reinforcement learning to generate initial values for the time series of control, the time required to search for a time series with a good evaluation as indicated by the evaluation function is expected to be relatively short, thereby reducing the time required for learning performed by the model control learning portion 193.

For each of the multiple tasks, the model control learning portion 193 learns control for the control target using the neural ordinary differential equation already learned for the task for which reinforcement learning has already been performed.

Note that in the learning phase, it is not necessary for the learning device 100 to perform actual control over the control target. In other words, the learning device 100 may not output control commands to the actual machine to be controlled.

The model control learning portion 193 learns control over the control target using an evaluation function (objective function) that corresponds to the policy function used by the reinforcement learning portion 191 for reinforcement learning. This allows the reinforcement learning performed by the reinforcement learning portion 191 and the learning performed by the model control learning portion 193 to have consistent control over the control target.

For example, the reinforcement learning portion 191 may perform reinforcement learning as shown in Expression (4).

$${arg max}_{π} {\sum }_{t = 0}^{∞} {E}_{{a}_{{t}^{∼ p} π} ( {a}_{r} \vert {\hat{s}}_{t} )} [ {γ}^{t} r ( {\hat{s}}_{t} , {a}_{t} ) ] , \qquad ( 4 )$$

$$subject to$$

$${\hat{s}}_{t + 1} ∼ {p}_{\hat{f}} ( {\hat{s}}_{t + 1} \vert {\hat{s}}_{t} , {a}_{t} )$$

r (s\hat{ }ₜ, aₜ) represents the reward obtained when the control target performs an action (operation) aₜ under the state s\hat{ }ₜ at time t.

γ is a constant of 0≤γ≤1 that represents the discount rate for future compensation earned.

Σₜ₌₀^{∞}E_{at˜pπ}(aₜ|s\hat{ }ₜ) [γ^{t}r (s\hat{ }ₜ, aₜ)] represents the expected value of the cumulative reward from time t=0 to t=∞ when the operation at of the control target is determined according to policy π under state s\hat{ }ₜ. Σₜ₌₀E_{at˜pπ}(aₜ|s\hat{ }ₜ) [γ^{t}r (s\hat{ }ₜ, aₜ)] corresponds to an example of a reward function.

argmax is a function that outputs the value of the parameter shown below argmax such that the value of the expression shown behind (to the right of) argmax is the maximum.

argmax_{π}Σₜ₌₀^{∞}E_{at˜pπ}(aₜ|s\hat{ }ₜ) [γ^{t}r (s\hat{ }ₜ, aₜ)] represents the search for a policy π such that the expected value of the aforementioned cumulative reward is as large as possible.

s\hat{ }ₜ₊₁˜_{pf\hat{ }}(s\hat{ }ₜ₊₁|s\hat{ }ₜ, aₜ) represents the transition from state s\hat{ }ₜ to state s\hat{ }ₜ₊₁ based on the predetermined transition probability when the control target performs operation at under state s\hat{ }ₜ. This state transition probability is used as a constraint when the reinforcement learning portion 191 searches for policy x in reinforcement learning.

The model control learning portion 193 may be used to learn control over the control target on the basis of Expression (5).

$${arg min}_{{a}_{0}} {\sum }_{t = 0}^{T} l ( {s}_{t} , {a}_{t} ) , \qquad ( 5 )$$

$$subject to$$

$${s}_{t + 1} = f ( {s}_{t} , {a}_{t} )$$

l(sₜ, aₜ) is a function that indicates the evaluation when the control target performs operation aₜ under the state sₜ. In the example in Expression (5), a cost function is used as the function l, where the smaller the function value, the better the evaluation.

Σₜ₌₀^{T}l(sₜ, aₜ) represents the sum of the evaluation values l(sₜ, aₜ) from time t=0 to t=T. Σₜ₌₀^{T}l(sₜ, aₜ) corresponds to an example of the objective function.

argmin is a function that outputs the value of the parameter shown below argmin such that the value of the expression shown behind (to the right of) argmin is minimized.

argminₐ₀Σₜ₌₀^{T}l(sₜ, aₜ) represents the search for an operation a₀ such that the sum of the evaluation values l(sₜ, aₜ) from time t=0 to t=T is as small as possible.

The expected value E_{at˜pπ}(aₜ|s\hat{ }ₜ) [γ^{t}r (s\hat{ }ₜ, aₜ)] shown in Expression (4) can be viewed as a function with state s\hat{ }ₜ and operation a as arguments. The model control learning portion 193 uses a function l(sₜ, aₜ) such that the larger the expected value E_{at˜pπ}(aₜ|sₜ) [γ^{t}r(sₜ, aₜ)], the smaller the function value (the value of l(sₜ, aₜ)). This allows for consistency between the search for a policy by the reinforcement learning portion 191 in reinforcement learning and the search for the operation of the control target by the model control learning portion 193 for the same task.

For example, consider the case where a function that outputs a negative or zero real number is used as the function r in Expression (4), such that the larger the value of the function r (and thus the larger the value of Σₜ₌₀^{∞}E_{at˜pπ}(aₜ|s\hat{ }ₜ) [γ^{t}r (s\hat{ }ₜ, aₜ)] in Expression (4)) the better the evaluation. In this case, the function l in Expression (5) may be a function of the function r multiplied by −1. That is, l(sₜ, aₜ)=−r(sₜ, aₜ) may be used. This allows the smaller value of the function l(and thus the smaller value of Σₜ₌₀^{T}l(sₜ, aₜ) in Expression (5)) to represent a better evaluation.

However, the relationship between the reward function used by the reinforcement learning portion 191 and the evaluation function (objective function) used by the model control learning portion 193 is not limited to a specific relationship.

The updating of the time series of control over the control target by the model control learning portion 193 can be viewed as learning control over the control target using a method of model predictive control.

However, the learning of control over the control target by the model control learning portion 193 is not limited to learning using a model predictive control method. As the method for the model control learning portion 193 to learn control over the control target, it is possible to use various optimal control methods, utilizing an evaluation function tailored to the task performed by the control target and capable of making use of the gradient information indicated by the neural ordinary differential equation, to search for a control command for the control target.

The model control learning portion 193 may update the policy obtained by reinforcement learning by the reinforcement learning portion 191 based on the results of learning control over the control target.

The simulator portion 194 simulates the operation of the control target. Specifically, the simulator portion 194 calculates the next state based on the state and the operation of the control target. The model of the control target used by the simulator portion 194 for simulation may be a non-differentiable model (a model for which gradient information cannot be calculated directly).

The reinforcement learning portion 191 performs reinforcement learning of control over the control target using simulation of the operation of the control target by the simulator portion 194.

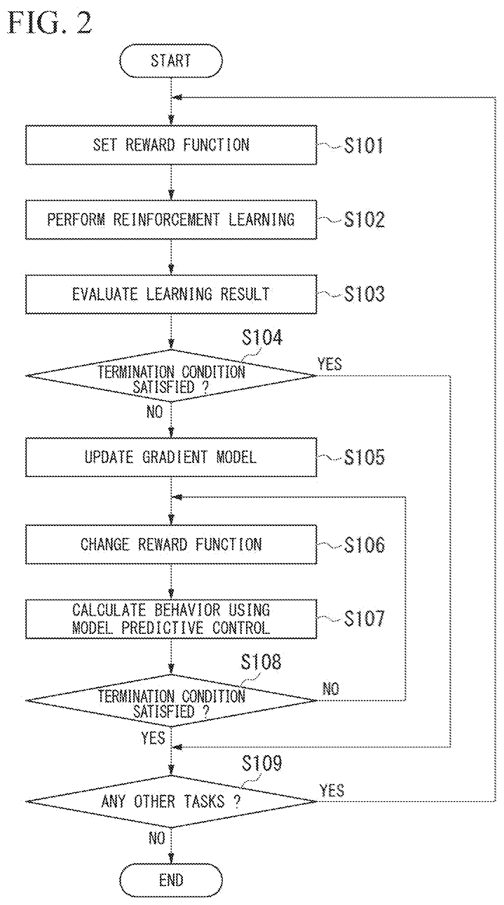

FIG. 2 is a drawing that shows an example of the steps of the process performed by the learning device 100.

In the process shown in FIG. 2, the reinforcement learning portion 191 sets the reward function (Step S101). The method by which the reinforcement learning portion 191 sets and updates the reward function is not limited to any particular method. For example, the reinforcement learning portion 191 may use a method of setting and updating the reward function as shown in known reinforcement learning methods.

Next, the learning device 100 performs reinforcement learning using the reward function set in Step S101 (Step S102). In Step S102, the learning device 100 conducts learning of control for the control target with respect to one of the tasks to be performed by the control target. The task under study is also referred to as the target task.

Next, the reinforcement learning portion 191 evaluates the learning results in the reinforcement learning (Step S103).

Next, the processing portion 190 determines whether the conditions for termination of learning for the target task are satisfied based on the evaluation results in Step S103 (Step S104).

The conditions for completion of the learning here are not limited to any specific ones. For example, the termination condition in Step S104 may be that the processing steps in the reinforcement learning have been repeated a predetermined number of times or more. Alternatively, the termination condition in Step S104 may be that the evaluation indicated by the reward function value is equal to or greater than a predetermined value.

If the processing portion 190 determines that the conditions for termination of learning for the target task have not been met (Step S104: NO), the model learning portion 192 updates the neural ordinary differential equation by learning the neural ordinary differential equation using the data obtained in the reinforcement learning in Step S102 (Step S105).

Next, the reinforcement learning portion 191 changes the reward function (Step S106).

Next, the model control learning portion 193 calculates the behavior of the control target using the model predictive control method (Step S107).

Next, the processing portion 190 determines whether the conditions for termination of learning using the model predictive control method for the target task are satisfied (Step S108).

The conditions for termination of learning here are not limited to any specific ones. For example, the termination condition in Step S107 may be that the processing steps in the learning performed by the model control learning portion 193 have been repeated a predetermined number of times or more. Alternatively, the termination condition in Step S107 may be that the evaluation indicated by the objective function value is equal to or better than a predetermined value.

When the processing portion 190 determines that the condition for termination of learning using the model predictive control method for the target task has not been met (Step S108: NO), the process returns to Step S106.

On the other hand, if it is determined that the condition for termination of learning using the model predictive control method for the target task has been met (Step S108: YES), the processing portion 190 determines whether or not there are tasks to be executed by the control target that have not yet been learned (Step S109).

If it is determined that there are tasks that have not been learned (Step S109: YES), the process returns to Step S101. In this case, the learning device 100 sets one of the unlearned tasks as the target task and performs the process from Step S101.

On the other hand, if the processing portion 190 determines in Step S104 that the condition for termination of learning of the target task is satisfied (Step S104: YES), the process proceeds to Step S109.

On the other hand, if the processing portion 190 determines in Step S108 that the termination condition of model predictive control for the target task is not satisfied (Step S108: NO), the process returns to Step S106.

On the other hand, if the processing portion 190 determines in Step S109 that no task has yet been learned among the tasks to be executed by the control target (Step S109: NO), the learning device 100 terminates the processing in FIG. 2.

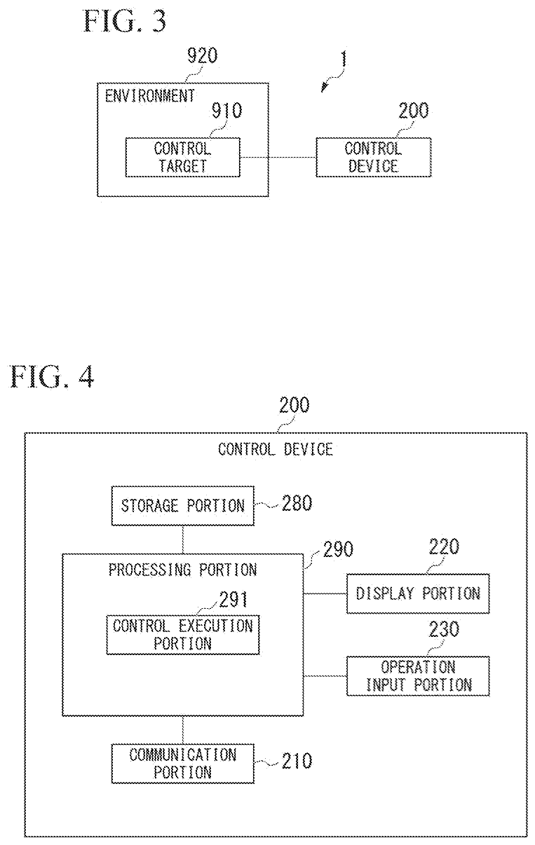

FIG. 3 is a diagram that shows an example of the system configuration when control is performed on a control target. In the configuration shown in FIG. 3, the system 1 is provided with a control device 200 and a control target 910. The operating environment of the control target, including the control target 910, is denoted as an environment 920.

The control target 910 is the control target that the learning device 100 targets for control learning.

The control device 200 performs control over the control target 910 based on observed data of the state of the environment 920 using the results of learning by the learning device 100. For example, the control device 200 performs control over the control target 910 using the policy obtained by reinforcement learning by the reinforcement learning portion 191 of the learning device 100, updated by the model control learning portion 193 based on the results of learning control over the control target.

The control device 200 may be configured using a computer, such as a personal computer or workstation. The control device 200 may be implemented in a computer on which the learning device 100 is implemented. Alternatively, the control device 200 may be implemented on a different computer than the computer on which the learning device 100 is implemented.

FIG. 4 is a drawing that shows an example of the configuration of the control device 200. In the configuration shown in FIG. 4, the control device 200 is provided with a communication portion 210, a display portion 220, an operation input portion 230, a storage portion 280, and a processing portion 290. The processing portion 290 is provided with a control execution portion 291.

The communication portion 210 communicates with other devices. For example, the communication portion 210 may transmit control commands to the control target 910 and receive sensor measurement values from sensors in the environment 920.

The display portion 220 has a display screen, such as an LCD or LED panel, for example, and displays various images. For example, the display portion 220 may display information about control over the control target 910, such as control commands to the control target 910.

The operation input portion 230 is provided with input devices such as a keyboard and mouse, for example, and receives user operations. For example, the operation input portion 230 may receive user operations to configure settings related to control over the control target 910, such as information on the communication address of the control target 910.

The storage portion 280 stores various data. For example, the storage portion 280 may store various information for control over the control target 910, such as control storage for control over the control target 910. The storage portion 280 is configured using a storage device provided by the control device 200.

The processing portion 290 controls various parts of the control device 200 to perform various processes. The functions of the processing portion 290 are performed, for example, by the CPU provided by the control device 200, which reads and executes a program from the storage portion 280.

The control execution portion 291 performs control over the control target 910 based on observed data of the state of the environment 920 using the results of learning by the learning device 100.

Specifically, the control execution portion 291 receives sensor measurement values by the sensors in the environment 920 via the communication portion 210, and determines a control command for the control target 910 by inputting the obtained sensor measurement values using the control rules obtained as a result of learning by the learning device 100. The control execution portion 291 then transmits the determined control command to the control target 910 via the communication portion 210.

As described above, the reinforcement learning portion 191 performs reinforcement learning of control over the control target. The model learning portion 192 learns the gradient model using the data used for reinforcement learning. The gradient model is a model that shows the relationship between the state relating to the control target, the control over the control target, and the time variation of the state relating to the control target. The model control learning portion 193 uses the gradient model and the result of reinforcement learning to learn control over the control target.

According to the learning device 100, learning of control over the control target can be performed by reinforcement learning and learning using the gradient model. In learning using the gradient model, it is expected that learning can be performed in a relatively short time using a learning method that uses a gradient method such as backpropagation.

According to the learning device 100, it is expected that the time required to learn the control over the control target is relatively short in this respect.

In addition, the learning device 100 is expected to have high interpolation when the model control learning portion 193 uses the gradient model, in that the model learning portion 192 uses the data used for reinforcement learning to perform learning of the gradient model. In other words, the argument values that the model control learning portion 193 inputs to the gradient model are within the range of learned argument values, and so in this respect, the accuracy of the gradient model output values is expected to be relatively high.

According to the learning device 100, it is expected that the model control learning portion 193 can learn control over the control target with relatively high accuracy in this respect.

The model control learning portion 193 uses the gradient model and the policy obtained by reinforcement learning to generate initial values for the time series of control over the control target, and updates the time series of control over the control target by learning control over the control target.

Here, if the accuracy of the initial values of the time series of control to the control target used by the model control learning portion 193 is low, it may take time to search for time series with good evaluations indicated by the evaluation function, and the time required for learning performed by the model control learning portion 193 may be relatively long.

In contrast, if the model control learning portion 193 uses the (tentative) results of reinforcement learning to generate initial values for the time series of control, the time required to search for a time series with a good evaluation as indicated by the evaluation function is expected to be relatively short, thereby reducing the time required for learning performed by the model control learning portion 193.

Also, the reinforcement learning portion 191 performs reinforcement learning for each of the multiple tasks to be performed by the control target. The model learning portion 192 updates the model by performing learning of a gradient model, using the data used for reinforcement learning for each of the multiple tasks to be performed by the control target. The model control learning portion 193, for each of the multiple tasks, conducts learning of control for the control target using the learned gradient model for each of the tasks for which reinforcement learning has already been performed.

Here, reinforcement learning is generally highly task-dependent, and a policy obtained through reinforcement learning may be less accurate in determining actions for tasks other than those that have already been learned. In contrast, in the learning device 100, the model learning portion 192 learns a task-independent gradient model. It is expected that this gradient model can be used to efficiently learn tasks other than those that have already been learned. For example, the reinforcement learning portion 191 may use a gradient model to set initial values in reinforcement learning for the next target task.

The reinforcement learning portion 191 also determines the initial value of the policy used for reinforcement learning using the gradient model learned in relation to the task for which reinforcement learning has been performed.

Here, when no learning results have been accumulated, such as in the early stages of reinforcement learning, it is conceivable to use a policy in which actions are determined randomly. In this case, the likelihood of an action being selected that will result in a good evaluation shown as a reward is relatively low, and it is conceivable that learning may take time. Similarly, if the learning of individual tasks does not use the results of learning from previous tasks, a policy that randomly determines actions may be used, which may take longer to learn.

In contrast, the reinforcement learning portion 191 determines initial values of a policy using a neural ordinary differential equation that has already been learned for a task for which reinforcement learning has already been performed, so that policy decisions can reflect the results of previous task learning. According to the learning device 100, in this respect, it is expected to be easier to select actions that will result in a better evaluation than when using a policy that randomly determines actions, and the time required for learning is expected to be relatively short.

The reinforcement learning portion 191 also determines the reward function used for reinforcement learning using the gradient model learned in relation to the task for which reinforcement learning has been performed.

Here, when learning the reward function, it is conceivable that the policy function cannot be properly learned until the learning progresses and an appropriate reward function is obtained. It is conceivable that the learning may take time, especially if the number of parameters to be learned in the reward function is large, such as when the reward function includes the calculation of cumulative rewards and the coefficients for each time step are subject to learning.

In contrast, by having the reinforcement learning portion 191 determine the reward function for reinforcement learning using the neural ordinary differential equation that has already been learned for the task for which reinforcement learning has already been performed, the determination of the reward function can reflect the results of the previous task learning. According to the learning device 100, in this respect, the reward function can be obtained in a shorter time than if the learning results of a task for which reinforcement learning has already been performed are not used, and as a result, it is also anticipated that the time required for policy learning will be relatively short.

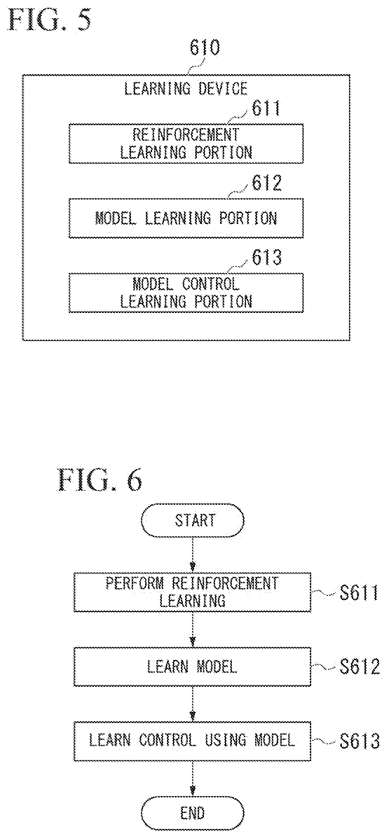

FIG. 5 is a drawing showing another example of the configuration of a learning device according to the example embodiment. In the configuration shown in FIG. 5, a learning device 610 is provided with a reinforcement learning portion 611, a model learning portion 612, and a model control learning portion 613.

In such a configuration, the reinforcement learning portion 611 performs reinforcement learning of control over the control target. The model learning portion 612 uses the data used for reinforcement learning to control the gradient model. The gradient model is a model that shows the relationship between the state relating to the control target, the control over the control target, and the time variation of the state relating to the control target. The model control learning portion 613 uses the gradient model and the result of reinforcement learning to learn control over the control target.

The reinforcement learning portion 611 corresponds to an example of a reinforcement learning means. The model learning portion 612 corresponds to an example of a model learning means. The model control learning portion 613 corresponds to an example of a model control learning means.

According to the learning device 610, learning of control over the control target can be performed by reinforcement learning and learning using the gradient model. In learning using the gradient model, it is expected that learning can be performed in a relatively short time using a learning method that uses a gradient method such as backpropagation.

According to the learning device 610, it is expected that the time required to learn the control over the control target is relatively short in this respect.

In addition, the learning device 610 is expected to have high interpolation when the model control learning portion 613 uses the gradient model, in that the model learning portion 612 uses the data used for reinforcement learning to perform learning of the gradient model. In other words, the argument values that the model control learning portion 613 inputs to the gradient model are within the range of learned argument values, and so in this respect, the accuracy of the gradient model output values is expected to be relatively high.

According to the learning device 610, it is expected that the model control learning portion 613 can learn control over the control target with relatively high accuracy in this respect.

The reinforcement learning portion 611 can be realized, for example, using functions such as the reinforcement learning portion 191 in FIG. 1. The model learning portion 612 can be realized, for example, using functions such as the model learning portion 192 in FIG. 1. The model control learning portion 613 can be realized, for example, using functions such as the model control learning portion 193 in FIG. 1.

FIG. 6 is a drawing showing an example of the processing steps in the learning method according to the example embodiment. The learning method shown in FIG. 6 includes performing reinforcement learning (Step S611), learning a model (Step S612), and learning control using the model (Step S613).

In performing reinforcement learning (Step S611), the computer performs reinforcement learning of the control over the control target.

In learning a model (Step S612), the computer performs learning of the gradient model using the data used for reinforcement learning. The gradient model is a model that shows the relationship between the state relating to the control target, the control over the control target, and the time variation of the state relating to the control target.

In learning control using the model (Step S613), the computer uses the gradient model and the results of reinforcement learning to learn control over the control target.

According to the learning method shown in FIG. 6, learning of control over the control target can be performed by reinforcement learning and learning using a gradient model. In learning using the gradient model, it is expected that learning can be performed in a relatively short time using a learning method that uses a gradient method such as backpropagation.

According to the learning method shown in FIG. 6, it is expected that the time required to learn the control over the control target is relatively short in this respect.

In addition, the learning method shown in FIG. 6 is expected to provide high interpolation when using the gradient model, in that the data used for reinforcement learning is used to train the gradient model. In other words, the argument values input to the gradient model are within the range of learned argument values, and so in this respect, the accuracy of the gradient model output values is expected to be relatively high.

The learning method shown in FIG. 6 is expected to be able to learn control over the control target with relatively high accuracy in this respect.

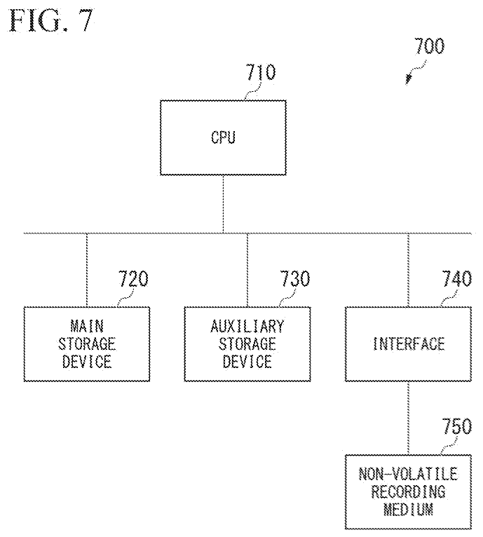

FIG. 7 is a schematic block diagram showing the configuration of a computer according to at least one example embodiment.

In the configuration shown in FIG. 7, a computer 700 is provided with a CPU 710, a main storage device 720, an auxiliary storage device 730, an interface 740, and a nonvolatile recording medium 750.

Any one or more of the aforementioned learning device 100, control device 200, and learning device 610, or any part thereof, may be implemented in the computer 700. In that case, the operations of each of the above-mentioned processing portions are stored in the auxiliary storage device 730 in the form of a program. The CPU 710 reads the program from the auxiliary storage device 730, deploys it in the main storage device 720, and executes the above processing according to the program. The CPU 710 also reserves a memory area in the main storage device 720 corresponding to each of the above-mentioned storage portions according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

When the learning device 100 is implemented in the computer 700, the operations of the processing portion 190 and its various parts thereof are stored in the auxiliary storage device 730 in the form of a program. The CPU 710 reads the program from the auxiliary storage device 730, deploys it in the main storage device 720, and executes the above processing according to the program.

The CPU 710 also reserves a storage area for the storage portion 180 in the main storage device 720 according to the program. Communication with other devices by the communication portion 110 is performed by the interface 740, which has communication functions and operates according to the control of the CPU 710. The display of images by the display portion 120 is performed by the interface 740, which is equipped with a display device and displays various images according to the control of the CPU 710. Reception of user operations by the operation input portion 130 is performed by the interface 740 being equipped with an input device and receiving user operations according to the control of the CPU 710.

When the control device 200 is implemented in the computer 700, the operations of the processing portion 290 and its various portions thereof are stored in the auxiliary storage device 730 in the form of a program. The CPU 710 reads the program from the auxiliary storage device 730, deploys it in the main storage device 720, and executes the above processing according to the program.

The CPU 710 also reserves a storage area for the storage portion 180 in the main storage device 720 according to the program. Communication with other devices by the communication portion 210 is performed by the interface 740, which has communication functions and operates according to the control of the CPU 710. The display of images by the display portion 220 is performed by the interface 740, which is equipped with a display device and displays various images according to the control of the CPU 710. Reception of user operations by the operation input portion 230 is performed by the interface 740 being equipped with an input device and receiving user operations according to the control of the CPU 710.

When the learning device 610 is implemented in the computer 700, the operations of the reinforcement learning portion 611, the model learning portion 612, and the model control learning portion 613 are stored in the auxiliary storage device 730 in the form of programs. The CPU 710 reads the program from the auxiliary storage device 730, deploys it in the main storage device 720, and executes the above processing according to the program.

The CPU 710 also allocates storage space in the main storage device 720 for processing by the learning device 610 according to the program. Communication between the learning device 610 and other devices is performed by the interface 740, which has communication functions and operates according to the control of the CPU 710. The interaction between the learning device 610 and the user is performed by the interface 740 having input and output devices, presenting information to the user with the output devices according to the control of the CPU 710, and receiving user operations with the input devices.

Any one or more of the above programs may be recorded on the nonvolatile recording medium 750. In this case, the interface 740 may read the program from the nonvolatile recording medium 750. The CPU 710 may then directly execute the program read by the interface 740, or the program may be stored once in the main storage device 720 or the auxiliary storage device 730 and then executed.

A program for executing all or part of the processes performed by the learning device 100, the control device 200, and the learning device 610 may be recorded on a computer-readable recording medium, and a computer system may read and execute the program recorded on this recording medium to perform the processing of each part. The term “computer system” here shall include an operating system (OS) and hardware such as peripheral devices.

In addition, “computer-readable recording medium” means a portable medium such as a flexible disk, magneto-optical disk, Read Only Memory (ROM), Compact Disc Read Only Memory (CD-ROM), or other storage device such as a hard disk built into a computer system. The aforementioned program may be used to realize some of the aforementioned functions, and may also be used to realize the aforementioned functions in combination with programs already recorded in the computer system.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

Some or all of the above example embodiments may also be described as, but not limited to, the following Supplementary Notes.

### (Supplementary Note 1)

A learning device provided with: a reinforcement learning means that performs reinforcement learning of control over a control target;
a model learning means that uses data used in the reinforcement learning to learn a model that shows the relationship between a state relating to the control target, control over the control target, and a temporal change in the state relating to the control target; and
a model control learning means that uses the model and the result of the reinforcement learning to learn control over the control target.

### (Supplementary Note 2)

The learning device according to Supplementary Note 1, wherein the model control learning means uses the model and a policy obtained in reinforcement learning to generate initial values of the time series of control over the control target, and updates the time series of control over the control target in learning control over the control target.

### (Supplementary Note 3)

The learning device according to Supplementary Note 1 or 2, wherein the reinforcement learning means performs the reinforcement learning for each of a plurality of tasks to be executed by the control target;
the model learning means updates the model by learning the model using the data used for the reinforcement learning for each of the multiple tasks to be executed by the control target; and
the model control learning means, for each of the plurality of tasks, learns control over the control target using the model already learned with respect to the tasks for which reinforcement learning has already been executed.

### (Supplementary Note 4)

The learning device according to Supplementary Note 3, wherein the reinforcement learning means determines the initial value of a policy to be used for the reinforcement learning using the model that has already been learned for the task for which the reinforcement learning has been performed.

### (Supplementary Note 5)

The learning device according to Supplementary Note 3 or 4, wherein the reinforcement learning means determines a reward function to be used for the reinforcement learning using the model that has already been learned for the task for which the reinforcement learning has been performed.

### (Supplementary Note 6)

A learning method that includes a computer
performing reinforcement learning of control over a control target,
using data used in the reinforcement learning to learn a model that shows the relationship between a state relating to the control target, control over the control target, and a temporal change in the state relating to the control target; and
using the model and the result of the reinforcement learning to learn control over the control target.

### (Supplementary Note 7)

A program that causes a computer to
perform reinforcement learning of control over a control target,
use data used in the reinforcement learning to learn a model that shows the relationship between a state relating to the control target, control over the control target, and a temporal change in the state relating to the control target; and
use the model and the result of the reinforcement learning to learn control over the control target.

What is claimed is:

1. A learning device comprising:
at least one memory configured to store instructions; and
at least one processor configured to execute the instructions to:
perform reinforcement learning of control over a control target;
use data used in the reinforcement learning to learn a model that shows the relationship between a state relating to the control target, control over the control target, and a temporal change in the state relating to the control target; and
use the model and the result of the reinforcement learning to learn control over the control target.

2. The learning device according to claim 1, wherein the at least one processor is configured to execute the instructions to:
use the model and a policy obtained in reinforcement learning to generate initial values of the time series of control over the control target; and
update the time series of control over the control target in learning control over the control target.

3. The learning device according to claim 1, wherein the at least one processor is configured to:
perform the reinforcement learning for each of a plurality of tasks to be executed by the control target;
update the model by learning the model using the data used for the reinforcement learning for each of the multiple tasks to be executed by the control target; and
for each of the plurality of tasks, learn control over the control target using the model already learned with respect to the tasks for which reinforcement learning has already been executed.

4. The learning device according to claim 3, wherein the at least one processor is configured to determine the initial value of a policy to be used for the reinforcement learning using the model that has already been learned for the task for which the reinforcement learning has been performed.

5. The learning device according to claim 3, wherein the at least one processor is configured to execute instructions to determine a reward function to be used for the reinforcement learning using the model that has already been learned for the task for which the reinforcement learning has been performed.

6. The learning device according to claim 2, wherein the at least one processor is configured to:
perform the reinforcement learning for each of a plurality of tasks to be executed by the control target;
update the model by learning the model using the data used for the reinforcement learning for each of the multiple tasks to be executed by the control target; and
for each of the plurality of tasks, learn control over the control target using the model already learned with respect to the tasks for which reinforcement learning has already been executed.

7. The learning device according to claim 6, wherein the at least one processor is configured to determine the initial value of a policy to be used for the reinforcement learning using the model that has already been learned for the task for which the reinforcement learning has been performed.

8. The learning device according to claim 6, wherein the at least one processor is configured to execute instructions to determine a reward function to be used for the reinforcement learning using the model that has already been learned for the task for which the reinforcement learning has been performed.

9. A learning method executed by a computer, the learning method comprising:
performing reinforcement learning of control over a control target;
using data used in the reinforcement learning to learn a model that shows the relationship between a state relating to the control target, control over the control target, and a temporal change in the state relating to the control target; and
using the model and the result of the reinforcement learning to learn control over the control target.

10. A non-transitory storage medium storing a program that causes a computer that executes a learning method comprising:
performing reinforcement learning of control over a control target;
using data used in the reinforcement learning to learn a model that shows the relationship between a state relating to the control target, control over the control target, and a temporal change in the state relating to the control target; and
using the model and the result of the reinforcement learning to learn control over the control target.
